(19) United States
(12) Patent Application Publication
(10) Pub. No.: US 2018/0203940 A1
(43) Pub. Date: Jul. 19, 2018

(54) CONNECTION DESTINATION CONTROL DEVICE AND METHOD THEREOF

(71) Applicant: FUJITSU LIMITED, Kawasaki-shi (JP)

(72) Inventors: Ryosuke KATSUMA, Kawaguchi (JP); SHUNICHI NAKAYAMA, Katsushika (JP)

(73) Assignee: FUJITSU LIMITED, Kawasaki-shi (JP)

(21) Appl. No.: 15/868,273

(22) Filed: Jan. 11, 2018

(30) Foreign Application Priority Data
Jan. 16, 2017 (JP) 2017-005451

(51) Int. Cl. G06F 17/30; H04L 29/06; H04L 29/08; G06K 7/10; G06K 17/00

(52) U.S. Cl. CPC G06F 17/30876; H04L 65/1069; G06Q 30/0623; G06K 7/10861; G06K 17/0022; H04L 67/02

(57) ABSTRACT

A non-transitory computer-readable recording medium stores therein a program for causing a computer to execute a process including: acquiring a plurality of pieces of identification information contained in light detected based on an image photographed by a photographing device; referring to a storage unit that stores identification information and connection destination information associated with one of a plurality of hierarchies of a website in association with each other to specify a plurality of pieces of connection destination information associated respectively with the plurality of pieces of identification information; and selecting connection destination information associated with the highest hierarchy from the plurality of specified connection destination information as a connection destination according to the acquiring of the plurality of pieces of identification information.

### CROSS-REFERENCE TO RELATED APPLICATION

This application is based upon and claims the benefit of priority of the prior Japanese Patent Application No. 2017-005451, filed on Jan. 16, 2017, the entire contents of which are incorporated herein by reference.

### FIELD

The embodiments discussed herein are related to a connection destination control device, a method thereof, and a non-transitory computer-readable recording medium having stored therein a program thereof.

### BACKGROUND

There has been proposed a first technique in which information corresponding to a photographing position is provided to a photographing side whose photographing position is unknown. In the first technique, optical beacons are arranged at different positions in a region and different identification numbers are generated as optical signals from the respective optical beacons. A video camera in the region receives the optical signal from each optical beacon and detects the position of each optical beacon and the position of its own device based on the principle of triangulation.

There has also been proposed a second technique for acquiring an address of a site in which information on a thing being broadcasted in a broadcast program is described. In the second technique, a keyword matching a retrieval descriptor describing the name of the thing added to the broadcast program is searched and the address of the site associated with the keyword is acquired when the keyword is found from a site reference table.

Related techniques are disclosed in, for example, Japanese Laid-Open Patent Publication Nos. 2002-207073 and 2002-135672.

### SUMMARY

According to an aspect of the embodiments, provided is a non-transitory computer-readable recording medium having stored therein a program for causing a computer to execute a process including: acquiring a plurality of pieces of identification information contained in light detected based on an image photographed by a photographing device; referring to a storage unit that stores identification information and connection destination information associated with one of a plurality of hierarchies of a website in association with each other to specify a plurality of pieces of connection destination information associated respectively with the plurality of pieces of identification information; and selecting connection destination information associated with the highest hierarchy from the plurality of specified connection destination information as a connection destination according to the acquisition of the plurality of pieces of identification information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram illustrating an example of a commodity purchase support system according to first and second embodiments;

FIG. 2 is a perspective view illustrating an example of a commodity exhibition place in a venue where a specific event is held;

FIG. 3 is a table illustrating an example of a management table according to the first embodiment;

FIG. 4 is a schematic block diagram illustrating an example of a hardware configuration of a terminal device;

FIG. 5 is a schematic block diagram illustrating an example of a hardware configuration of a connection destination control server;

FIG. 6 is a flowchart illustrating an example of a photographing activation process according to the first embodiment;

FIG. 7A is an image diagram illustrating a case where an image is photographed close to a product;

FIG. 7B is an image diagram illustrating an example of a light source region detected from the image by the photographing illustrated in FIG. 7A;

FIG. 8A is an image diagram illustrating a case where a commodity exhibition place is photographed at a remote distance;

FIG. 8B is an image diagram illustrating an example of a light source region detected from an image by the photographing illustrated in FIG. 8A;

FIG. 9A is an image diagram illustrating a case where a commodity exhibition place is photographed at an intermediate distance;

FIG. 9B is an image diagram illustrating an example of a light source region detected from an image by the photographing illustrated in FIG. 9A;

FIG. 10 is a flowchart illustrating an example of a connection destination control process according to the first embodiment;

FIG. 11 is an image diagram illustrating an example of a commodity list page of a specific site displayed on a terminal device when photographing is performed close to a commodity;

FIG. 12 is an image diagram illustrating an example of a commodity list page of a specific site displayed on a terminal device when a commodity exhibition place is photographed at a remote distance;

FIG. 13 is a table illustrating an example of a management table according to a second embodiment;

FIG. 14 is a flowchart illustrating an example of a photographing activation process according to the second embodiment;

FIG. 15 is a flowchart illustrating an example of a connection destination control process according to the second embodiment;

FIG. 16 is a schematic block diagram illustrating an example of a commodity purchase support system according to a third embodiment;

FIG. 17 is a table illustrating an example of a management table according to the third embodiment; and

FIG. 18 is a flowchart illustrating an example of a connection destination control process according to the third embodiment.

### DESCRIPTION OF EMBODIMENTS

At a venue where an event gathering many people is held, when commodities are limitedly distributed for visitors, since a place of distribution in the venue will be congested due to the concentration of visitors, a problem such as long waiting time until purchase of commodities often occurs. In order to alleviate such congestion, for example, it is conceivable to connect a terminal device possessed by a visitor interested in a specific commodity to a predetermined website through which the specific commodity can be purchased by e-commerce in order to induce the visitor to purchase the specific commodity via the predetermined website. For example, with a selling place illuminated with light containing predetermined identification information, when the predetermined identification information is detected within a range photographed by the visitor with a terminal device, the visitor interested in the specific commodity may access the predetermined website, thereby inducing the visitor to the predetermined website.

However, there exist various processes leading people to purchase commodities. Some people purchase commodities only with information offered from websites and some people purchase commodities after checking samples of commodities exhibited in the selling place without minding some time and labor. In general, a website has a hierarchical structure and a terminal device possessed by a visitor who is supposed to purchase a commodity only with information offered on a website may be connected to a hierarchy including list information of a plurality of commodities in the website. In the meantime, a terminal device possessed by a visitor who desires to purchase a commodity after checking the sample of the commodity may be connected to a lower hierarchy in the website including the detailed information on commodities being seen by the visitor. If different ranges are illuminated with a plurality of lights including different identification information, it is necessary to appropriately select a connection destination when a plurality of identification information is detected within a photographing range.

In contrast, the first technique discussed above discloses generating an identification number as an optical signal from an optical beacon and the second technique discussed above discloses acquiring an address of a site in which information on an object is described. However, the first technique and the second technique do not disclose any selection of a connection destination when a plurality of identification information is detected within a photographing range.

Hereinafter, embodiments of the disclosed technology will be described in detail with reference to the accompanying drawings. In the following embodiments, as an example, an aspect in which commodities are limitedly distributed for users who visit a specific venue where a specific event is held will be described.

### First Embodiment

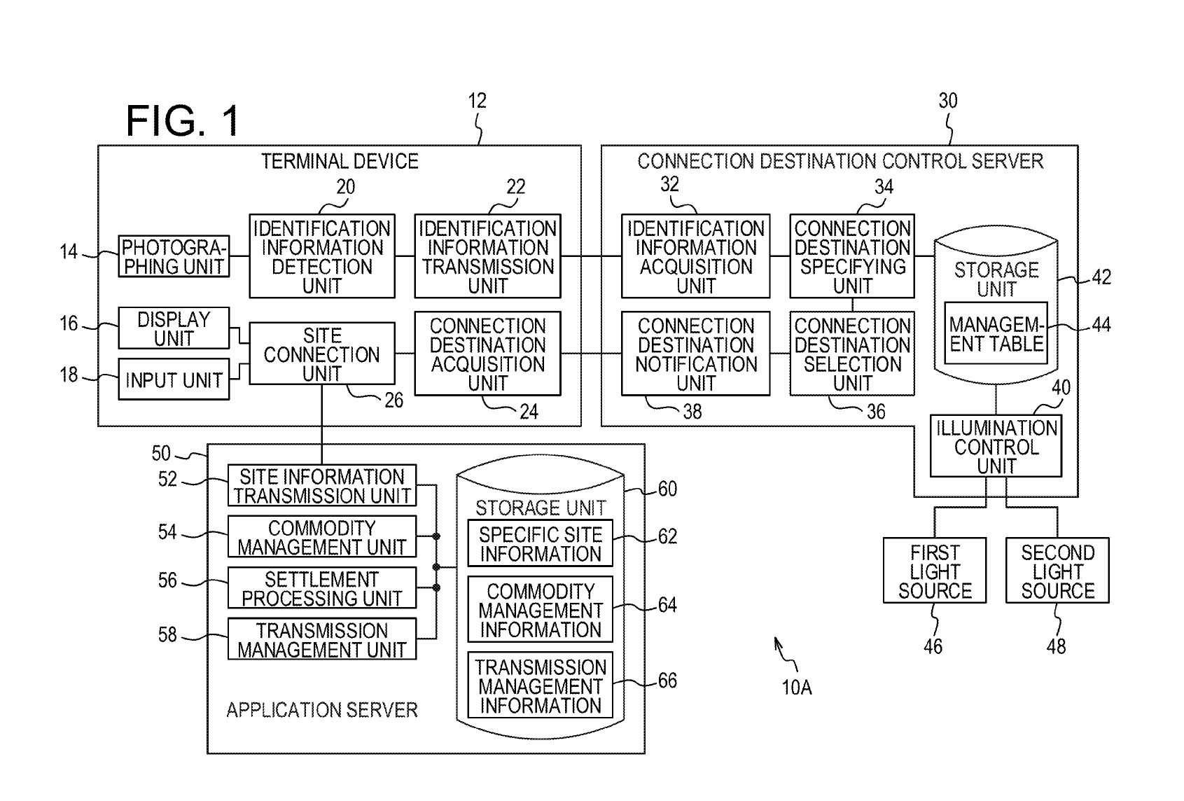

FIG. 1 illustrates a commodity purchase support system 10A according to a first embodiment. The commodity purchase support system 10A is provided for the purpose of assisting the purchase of limitedly-distributed commodities by users who visit a specific venue and alleviating the concentration of congestion on some places in the venue. The commodity purchase support system 10A includes a terminal device 12 possessed by an individual user who visits the specific venue, a connection destination control server 30, and an application server 50 capable of communicating with the terminal device 12.

The terminal device 12 includes a photographing unit 14, an identification information detection unit 20, an identification information transmission unit 22, a connection destination acquisition unit 24, a site connection unit 26, a display unit 16, and an input unit 18. The photographing unit 14 is an example of an imaging device recited in the present disclosure. The connection destination control server 30 includes an identification information acquisition unit 32, a connection destination specifying unit 34, a connection destination selection unit 36, a connection destination notification unit 38, a storage unit 42 that stores a management table 44, and an illumination control unit 40. The connection destination control server 30 is an example of a connection destination controller recited in the present disclosure and the identification information acquisition unit 32 is an example of an acquisition unit recited in the present disclosure. The connection destination specifying unit 34 is an example of a specifying unit recited in the present disclosure and the connection destination selection unit 36 is an example of a selection unit recited in the present disclosure. The application server 50 includes a site information transmission unit 52, a commodity management unit 54, a settlement processing unit 56, a delivery management unit 58 and a storage unit 60. The storage unit 60 stores specific site information 62, commodity management information 64 and delivery management information 66.

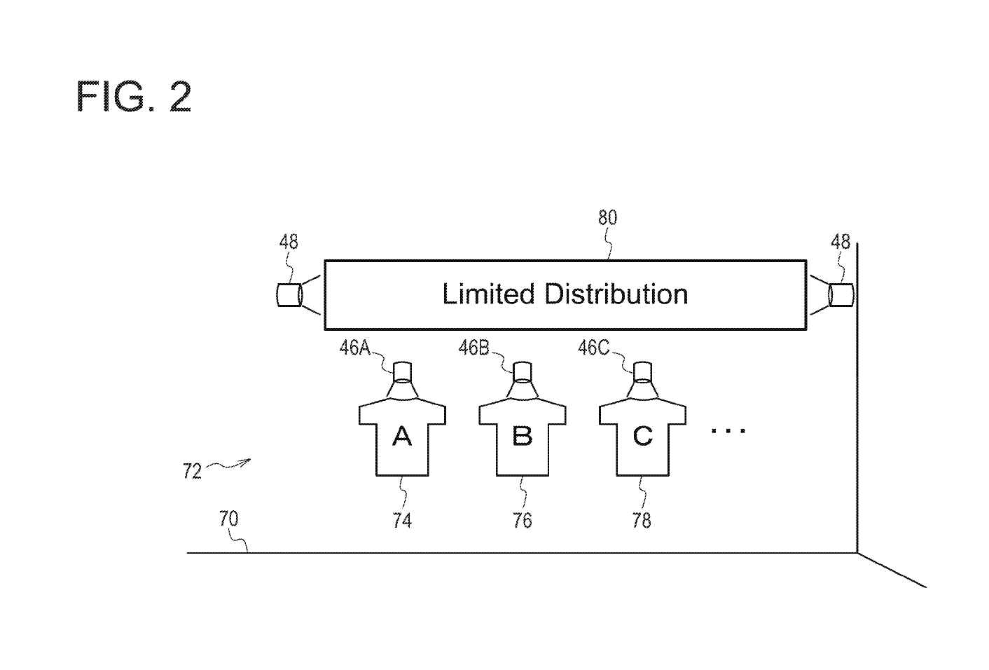

As illustrated in FIG. 2, a commodity exhibition place 72 exhibiting limitedly-distributed commodities is provided at a corner of a specific venue 70. FIG. 2 illustrates a T-shirt A74, a T-shirt B76, and a T-shirt C78 as an example of the commodities exhibited in the commodity exhibition place 72. The individual commodities exhibited in the commodity exhibition place 72 are illuminated with different first light sources 46. Specifically, the T-shirt A74 is illuminated with a first light source 46A, the T-shirt B76 is illuminated with a first light source 46B, and the T-shirt C78 is illuminated with a first light source 46C.

In addition, a signboard 80 is provided in the commodity exhibition place 72 above the exhibited commodities. A character string (“Limited Distribution” in the example of FIG. 2) indicating that the commodities are exhibited below is described on the signboard 80. By viewing the signboard 80, a user can recognize the position of the commodity exhibition place 72 even when the user is away from the commodity exhibition place 72. The signboard 80 is illuminated with second light sources 48. Although FIG. 2 illustrates an example in which a plurality of second light sources 48 are provided, the number of second light sources 48 may be one.

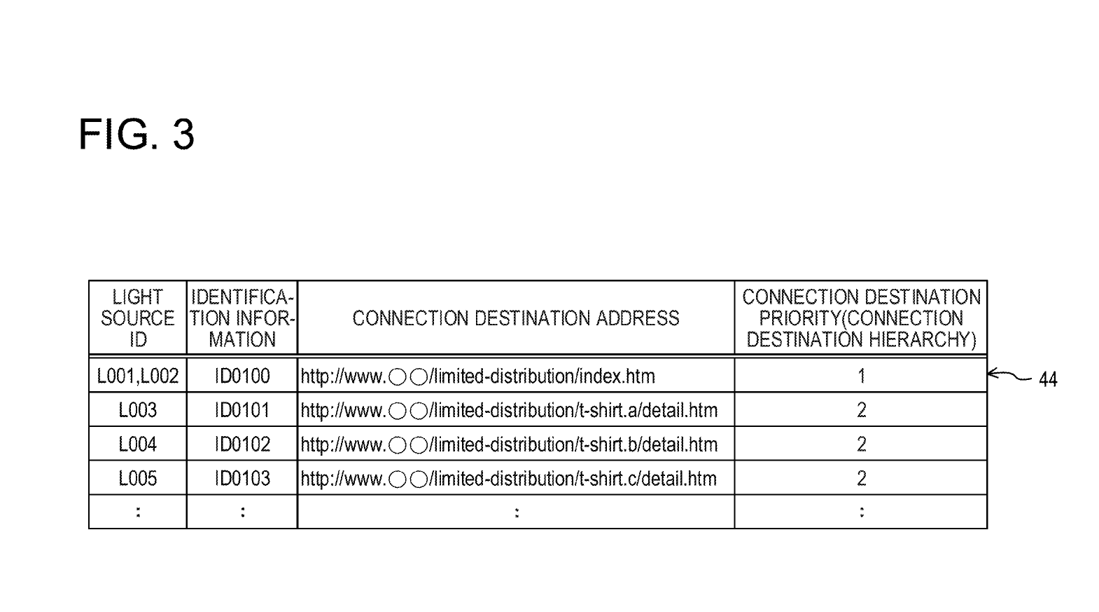

As illustrated in FIG. 1, the first light sources 46 and the second light sources 48 are connected to the illumination control unit 40 of the connection destination control server 30. As one example, as illustrated in FIG. 3, the management table 44 stored in the storage unit 42 includes light source IDs for individually identifying the first light sources 46 and the second light sources 48, and identification information contained in light from the corresponding light sources in association with each other. The illumination control unit 40 sequentially modulates the amount of light emitted from each of the first light sources 46 and the second light sources 48 according to the corresponding identification information so that the corresponding identification information is contained in the light.

As an example, in the present embodiment, the light source ID of the first light source 46A is “L003” and the T-shirt A74 is illuminated with light containing the identification information of “ID0101”, which is emitted the first light source 46A. The light source ID of the first light source 46B is “L004” and the T-shirt B76 is illuminated with light containing the identification information of “ID0102”, which is emitted the first light source 46B. The light source ID of the first light source 46C is “L005” and the T-shirt C78 is illuminated with light containing the identification information of “ID0103”, which is emitted the first light source 46C. The light source IDs of the two second light sources 48 are “L001” and “L002”, respectively, and the signboard 80 is illuminated with light containing the identification information of “ID0100”, which is emitted from the two second light sources 48.

In this example, the T-shirts A74 to C78 are an example of a first object recited in the present disclosure and the identification information contained in the light emitted from the first light sources 46A to 46C is an example of first identification information recited in the present disclosure. The signboard 80 is an example of a second object recited in the present disclosure and the identification information contained in the light emitted from the second light sources 48 is an example of second identification information recited in the present disclosure.

Although FIG. 2 illustrates a case where the commodity exhibition place 72 is an unattended place, there may be a person who explains the commodities to a user, or a salesperson who sells the commodities to a user who does not possess the terminal device 12.

When photographing is performed by the photographing unit 14, the identification information detection unit 20 of the terminal device 12 searches whether or not a region irradiated with light containing the identification information (hereinafter referred to as a “light source region”) is present within a range of the photographing by the photographing unit 14. When the first light source 46 itself, the second light source 48 itself, an object illuminated with the first light source 46, or the second light source 48 is present within the range of the photographing by the photographing unit 14, the light source region is detected by the identification information detection unit 20. Upon detecting the light source region within the range of the photographing by the photographing unit 14, the identification information detection unit 20 detects the identification information included in the detected light source region based on the temporal change in luminance of the detected light source region. When the identification information is detected by the identification information detection unit 20, the identification information transmission unit 22 of the terminal device 12 transmits the detected identification information to the connection destination control server 30.

The identification information acquisition unit 32 of the connection destination control server 30 acquires the identification information transmitted from the terminal device 12. The connection destination specifying unit 34 refers to the storage unit 42 storing the management table 44 to acquire a connection destination address and a connection destination priority associated with the identification information acquired by the identification information acquisition unit 32.

As an example, as illustrated in FIG. 3, connection destination addresses and connection destination priorities are registered in association with individual identification information in the management table 44. The connection destination address is an example of connection destination information recited in the present disclosure. In the present embodiment, a web site (hereinafter referred to as a “specific site”) that sells the commodities exhibited in the commodity exhibition place 72 on-line by an electronic commerce to users visiting the specific venue 70 is offered by an application server 50. The specific site has a hierarchical structure similar to a typical website and includes an individual commodity webpage displaying detailed information of each individual commodity and a commodity list webpage which is provided at a higher hierarchical level than the individual commodity webpage and displays information on a list of commodities. The specific site is an example of a “website having a plurality of hierarchies” recited in the present disclosure, the individual commodity webpage is an example of a first webpage recited in the present disclosure, and the commodity list webpage is an example of a second webpage recited in the present disclosure.

The connection destination addresses registered in the management table 44 are information for designating any one of the webpages included in the specific site as a connection destination in the form of, for example, a URL (Uniform Resource Locator) or the like. In the present embodiment, as the illumination range of the light from the light source in the venue 70 (the commodity exhibition place 72) becomes higher, the management table 44 is set such that a connection destination to be associated with the identification information included in the corresponding light become a higher hierarchical webpage in the specific site.

As an example, in FIG. 3, the identification information contained in the light from the first light source 46 having the illumination range distributed in the space of the commodity exhibition place 72 below the second light source 48 is the identification information “ID0101” to “ID0103”. The connection destination addresses registered in the management table 44 in association with the identification information “ID0101” to “ID0103” designate the individual commodity webpages of different commodities (T-shirt A74 to T-shirt C78) as connection destinations. The identification information contained in the light from the second light source 48 having the illumination range above the first light source 46 is the identification information “ID0100”. The connection destination address registered in the management table 44 in association with this identification information “ID0100” designates the commodity list webpage displaying a list of commodities (T-shirt A74 to T-shirt C78) as a connection destination. The connection destination priority is information indicating the hierarchy within the specific site of the webpage specified by the corresponding connection destination address as a relative order.

When the connection destination address and the connection destination priority are acquired by the connection destination specifying unit 34, the connection destination selection unit 36 determines whether or not there is a plurality of sets of connection destination addresses and connection destination priorities acquired by the connection destination specifying unit 34. In the present embodiment, when the identification information acquisition unit 32 acquires one piece of identification information from the terminal device 12, the connection destination specifying unit 34 acquires one set of connection destination address and connection destination priority. In this case, the connection destination selection unit 36 directly outputs the connection destination address acquired by the connection destination specifying unit 34 to the connection destination notification unit 38.

In the meantime, when the identification information acquisition unit 32 acquires a plurality of pieces of identification information from the terminal device 12, the connection destination specifying unit 34 acquires a plurality of sets of connection destination addresses and connection destination priorities. In this case, the connection destination selection unit 36 selects a set having the highest connection destination priority from the acquired plurality of sets of connection destination addresses and connection destination priorities. Then, the connection destination selection unit 36 outputs the connection destination address included in the selected set to the connection destination notification unit 38. The connection destination notification unit 38 transmits the connection destination address input from the connection destination selection unit 36 to the terminal device 12.

The connection destination acquisition unit 24 of the terminal device 12 acquires a connection destination address transmitted from the connection destination control server 30. The site connection unit 26 requests the application server 50 to transmit the corresponding webpage in the specific site by transmitting the connection destination address acquired by the connection destination acquisition unit 24 to the application server 50. Further, upon receiving the information on the webpage in the specific site from the application server 50, the site connection unit 26 causes the display unit 16 to display the webpage indicated by the received information.

When the user performs any input operation via the input unit 18 based on the webpage displayed on the display unit 16, the site connection unit 26 requests the application server 50 to transmit a new webpage according to the input operation. Upon receiving the information of the new webpage in the specific site from the application server 50, the site connection unit 26 causes the display unit 16 to display the received new webpage. With such information transmission and reception between the terminal device 12 and the application server 50, a process for the user to purchase a commodity t by e-commerce through the specific site is performed.

Information of each webpage included in the specific site is stored as the specific site information 62 in the storage unit 60 of the application server 50. Upon receiving the information requesting the transmission of the webpage in the specific site from the terminal device 12, the site information transmission unit 52 acquires the information of the requested webpage from the storage unit 60 and transmits it to the requesting terminal device 12.

Information such as inventory quantity of commodities distributed at the specific site is stored as the commodity management information 64 in the storage unit 60. The commodity management unit 54 checks the inventory quantity of commodities of the information included in the webpage transmitted by the site information transmission unit 52 to the terminal device 12 and adds the inventory quantity to the webpage. In addition, each time a commodity is purchased by a user through the specific site, the commodity management unit 54 performs a process of updating the inventory quantity or the like of commodities included in the commodity management information 64.

The settlement processing unit 56 performs a settlement process when a user purchases a commodity through the specific site. In addition, information such as a commodity delivery destination and a commodity delivery quantity is stored as the delivery management information 66 in the storage unit 60. Each time a commodity is purchased by a user through the specific site, the delivery management unit 58 updates the delivery management information 66 so that the commodity is delivered to a delivery destination desired by the user. In the present embodiment, at least one commodity delivery station (not illustrated) is provided in the specific venue 70 and a commodity purchased by a user who desires delivery at the commodity delivery station is transported to the commodity delivery station in company with updating the delivery management information 66.

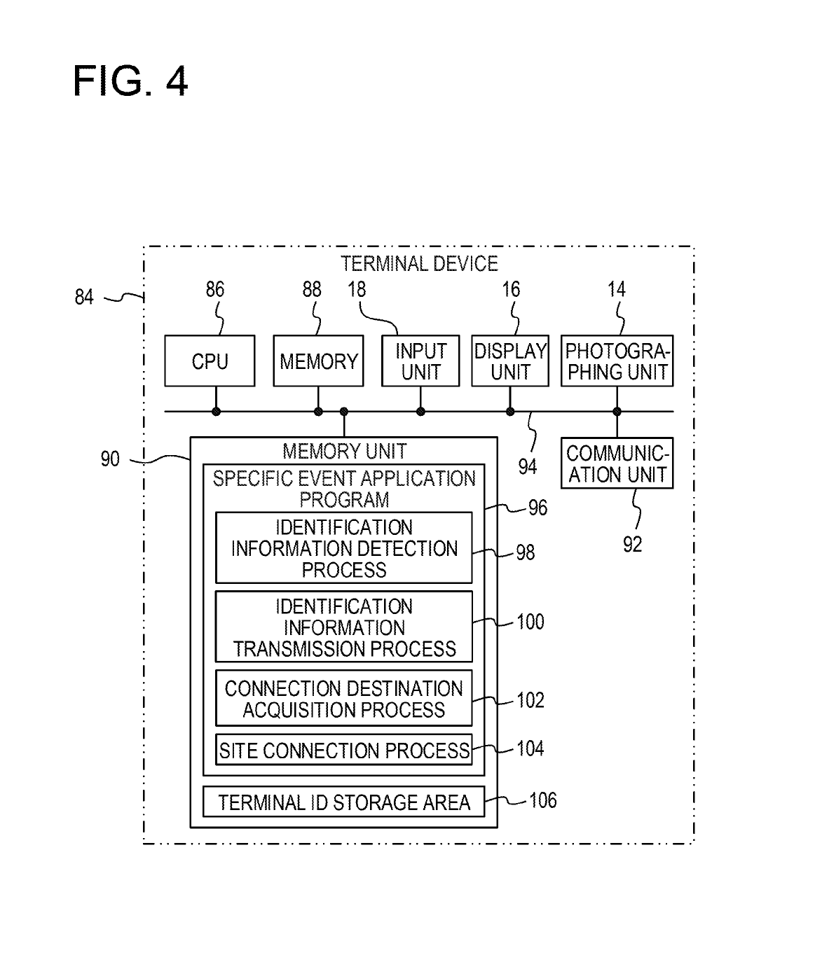

FIG. 4 illustrates a hardware configuration of a terminal device 84 functioning as the terminal device 12 illustrated in FIG. 1. The terminal device 84 includes a CPU 86, a memory 88, a nonvolatile storage unit 90, a display unit 16, an input unit 18, a photographing unit 14 and a communication unit 92. The CPU 86, the memory 88, the storage unit 90, the display unit 16, the input unit 18, the photographing unit 14 and the communication unit 92 are interconnected via a bus 94.

The storage unit 90 is implemented by a hard disk drive (HDD), a solid state drive (SSD), a flash memory or the like. A specific event application program 96 is stored in the storage unit 90. The specific event application program 96 is downloaded and installed in advance in accordance with an instruction of a user going to the venue 70 where a specific event is held. The CPU 86 reads the specific event application program 96 from the storage unit 90, deploys it into the memory 88, and sequentially executes processes of the specific event application program 96.

The specific event application program 96 includes an identification information detection process 98, an identification information transmission process 100, a connection destination acquisition process 102, and a site connection process 104. The CPU 86 operates as the identification information detection unit 20 illustrated in FIG. 1 by executing the identification information detection process 98. In addition, the CPU 86 operates as the identification information transmission unit 22 illustrated in FIG. 1 by executing the identification information transmission process 100. Further, the CPU 86 operates as the connection destination acquisition unit 24 illustrated in FIG. 1 by executing the connection destination acquisition process 102. Further, the CPU 86 operates as the site connection unit 26 illustrated in FIG. 1 by executing the site connection process 104. A terminal ID storage area 106 is provided in the storage unit 90 and terminal IDs are stored in advance in the terminal ID storage area 106. Accordingly, the terminal device 84 that executes the specific event application program 96 functions as the terminal device 12.

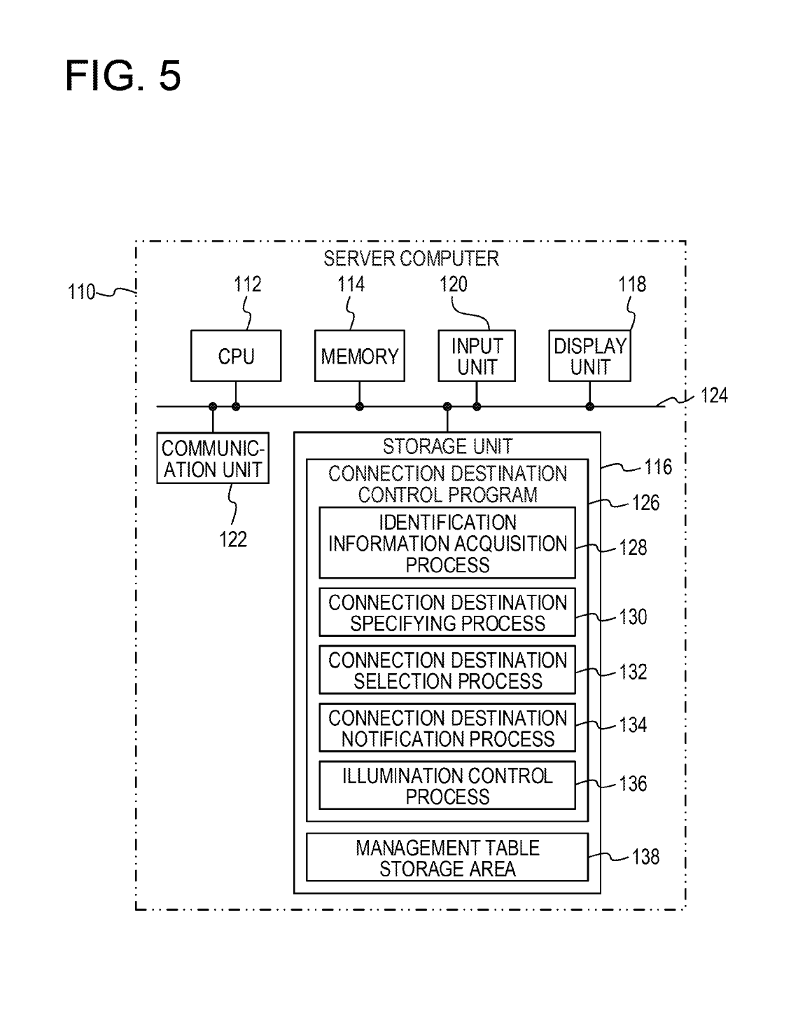

FIG. 5 illustrates a hardware configuration of a server computer 110 functioning as the connection destination control server 30 illustrated in FIG. 1. The server computer 110 includes a CPU 112, a memory 114, a storage unit 116, a display unit 118 such as a monitor, an input unit 120 such as a keyboard and a mouse, and a communication unit 122. The CPU 112, the memory 114, the storage unit 116, the display unit 118, the input unit 120, and the communication unit 122 are interconnected via a bus 124.

The storage unit 116 is implemented by an HDD, an SSD, a flash memory or the like. A connection destination control program 126 for causing the server computer 110 to function as the connection destination control server 30 is stored in advance in the storage unit 116. The CPU 112 reads the connection destination control program 126 from the storage unit 116, deploys it into the memory 114, and sequentially executes processes of the connection destination control program 126.

The connection destination control program 126 includes an identification information acquisition process 128, a connection destination specifying process 130, a connection destination selection process 132, a connection destination notification process 134, and an illumination control process 136. The CPU 112 operates as the identification information acquisition unit 32 illustrated in FIG. 1 by executing the identification information acquisition process 128. In addition, the CPU 112 operates as the connection destination specifying unit 34 illustrated in FIG. 1 by executing the connection destination specifying process 130. Further, the CPU 112 operates as the connection destination selection unit 36 illustrated in FIG. 1 by executing the connection destination selection process 132. Further, the CPU 112 operates as the connection destination notification unit 38 illustrated in FIG. 1 by executing the connection destination notification process 134. Further, the CPU 112 operates as the illumination control unit 40 illustrated in FIG. 1 by executing the illumination control process 136. A management table storage area 138 is provided in the storage unit 116, the management table 44 is stored in advance in the management table storage area 138, and the management table storage area 138 functions as the storage unit 42. Accordingly, the server computer 110 that executes the connection destination control program 126 functions as the connection destination control server 30. The connection destination control program 126 is an example of a connection destination control program recited in the present disclosure.

A server computer functioning as the application server 50 illustrated in FIG. 1 has the same hardware configuration as the server computer 110 illustrated in FIG. 5 except for programs and data stored in the storage unit 116. Therefore, explanation of the server computer functioning as the application server 50 will be omitted for the purpose of brevity.

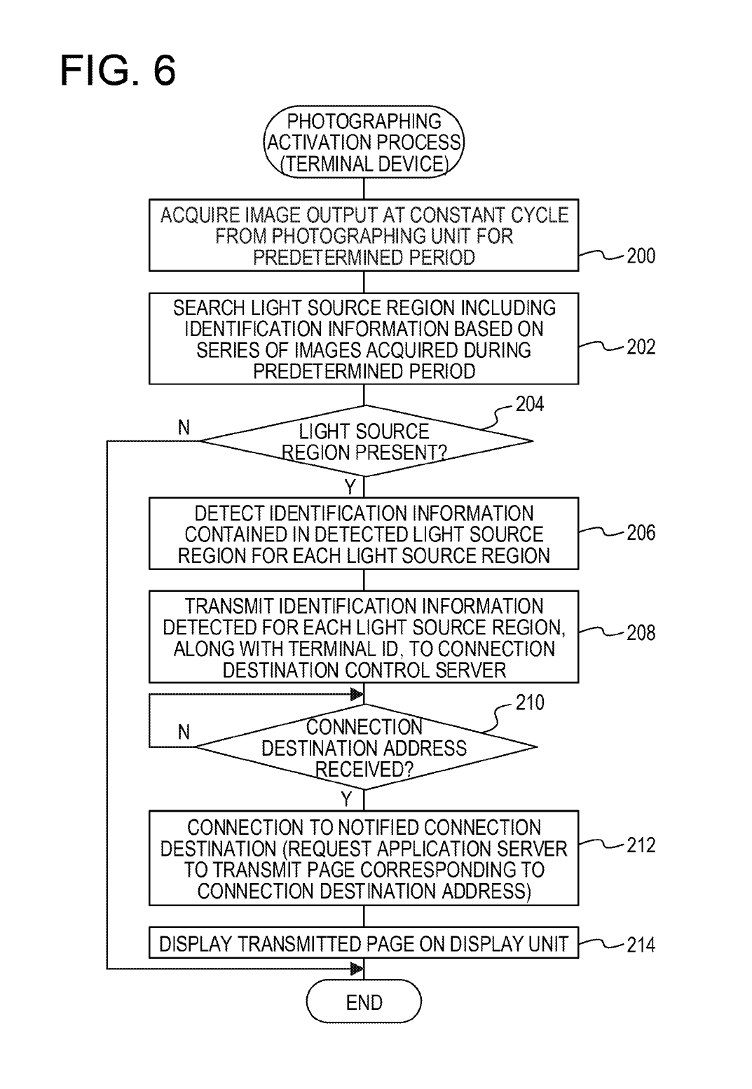

Next, the operation of the first embodiment will be described. When the photographing unit 14 is activated by the user's input operation, the terminal device 12 executes a photographing activation process illustrated in FIG. 6 as the specific event application program 96 is executed by the CPU 86.

In step 200 of the photographing activation process, the identification information detection unit 20 of the terminal device 12 acquires an image output at a certain cycle from the photographing unit 14 by photographing by the photographing unit 14 over a predetermined period, and stores the acquired series of images (a moving image) in the memory 88. Modulation of the light emitted from each of the first light source 46 and the second light source 48 by the illumination control unit 40 is sequentially performed. Therefore, the above-mentioned predetermined period is set to a time (for example, several seconds or so) longer than the time for one around of modulation for all the light sources 46 and 48 installed at the commodity exhibition place 72.

When the series of images are acquired over the predetermined period, in step 202, the identification information detection unit 20 searches for a light source area including identification information based on the series of images stored in the memory 88. The searching for the light source region is carried out, for example, by dividing one image frame into a plurality of partial regions, sequentially comparing the luminance at each time within a predetermined period for each of the partial regions, and determining whether or not there is a time zone in which a regular change in luminance is occurring within the predetermined period. Then, adjacent partial regions having the same time zone in which the regular change in luminance is occurring are integrated. Accordingly, when there is a region irradiated with light containing identification information within the range of photographing by the photographing unit 14, the corresponding region may be detected as a light source region.

In the next step 204, the identification information detection unit 20 determines whether or not a light source region has been detected by the search in step 202 from the series of images within the predetermined period photographed by the photographing unit 14. When the determination in step 204 is negative, since the user may determine that the photographing unit 14 of the terminal device 12 is not directed to the commodity exhibition place 72, the photographing activation process is ended. In the meantime, when the determination in step 204 is affirmative, since the user may determine that the photographing unit 14 of the terminal device 12 is directed to the commodity exhibition place 72, the process proceeds to step 206.

Here, when the user performs an operation of directing the photographing unit 14 of the terminal device 12 to the commodity exhibition place 72, an example of the relationship between a distance from the commodity exhibition place 72 to the user (terminal device 12) and a light source region detected from an image photographed by the photographing unit 14 will be described.

In the present embodiment, since commodities to be limitedly distributed to visitors of the specific venue 70 are exhibited in the commodity exhibition place 72, there is a possibility that people are concentrated and crowded in the vicinity of the commodity exhibition place 72. However, it is expected that there will be a first user who desires to check samples of the commodities exhibited in the commodity exhibition place 72 without minding some time and labor, among users who are interested in the commodities exhibited in the commodity exhibition place 72.

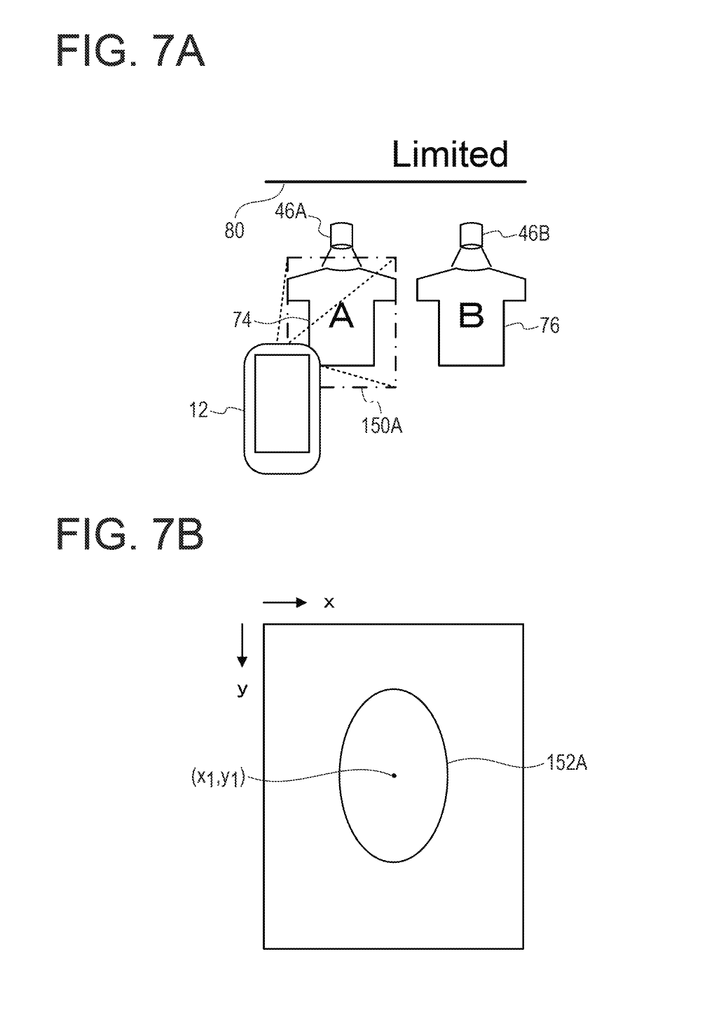

It is assumed that the first user waits until arriving in front of the commodities exhibited in the commodity exhibition place 72, checks the samples of the commodities, and, if the user has a purchase intention, takes an action of directing the photographing unit 14 of the terminal device 12 to a commodity that the user wishes to purchase, as an example, as illustrated in FIG. 7A. As an example, FIG. 7A illustrates a case where the photographing unit 14 of the terminal device 12 is directed to the T-shirt A74 exhibited in the commodity exhibition place 72. In this case, since the region of the T-shirt A74 illuminated with the light from the first light source 46A occupies most of a photographing range 150A, one light source region 152A illuminated with the light from the first light source 46A is detected from a photographed image, as illustrated in FIG. 7B. Further, in the present embodiment, the identification information “ID0101” is detected from the detected one light source region 152A.

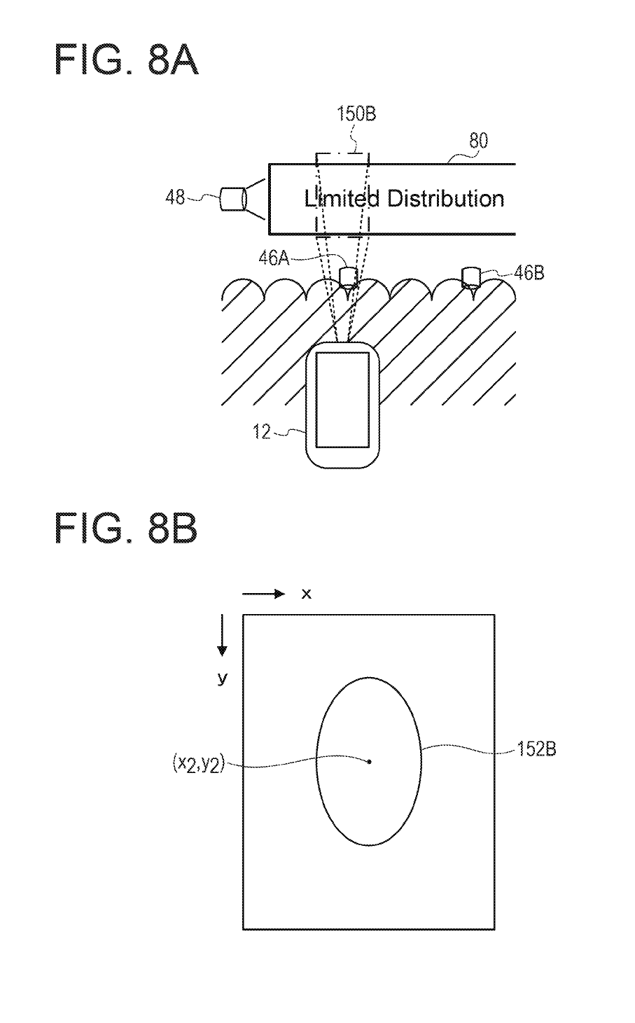

In addition, it is expected that there will also be a second user who wishes to check and select a commodity at the specific site, among the users who are interested in the commodities exhibited in the commodity exhibition place 72, taking into consideration the waiting time due to the concentration of people near the commodity exhibition place 72. As an example, FIG. 8A illustrates a case where the photographing unit 14 of the terminal device 12 is directed to the signboard 80 of the commodity exhibition place 72 at a position distant from the commodity exhibition place 72. In this case, since the region of the signboard 80 illuminated with the light from the second light source 48 occupies a large area in a photographing range 150B, one light source region 152B illuminated with the light from the second light source 48 is detected from a photographed image, as illustrated in FIG. 8B. Further, in the present embodiment, the identification information “ID0100” is detected from the detected one light source region 152B.

It may be also considered that a user takes an action to direct the photographing unit 14 of the terminal device 12 to the signboard 80 or the like of the commodity exhibition place 72 at the photographing position in FIG. 7A and the middle of the photographing position in FIG. 8A. As an example of taking the above action, for example, the first user may give up arriving in front of the commodities due to a higher concentration of people in the vicinity of the commodity exhibition place 72. In addition, the second user may approach the commodity exhibition place 72 closer than the photographing position in FIG. 8A due to a lower concentration of people in the vicinity of the commodity exhibition place 72.

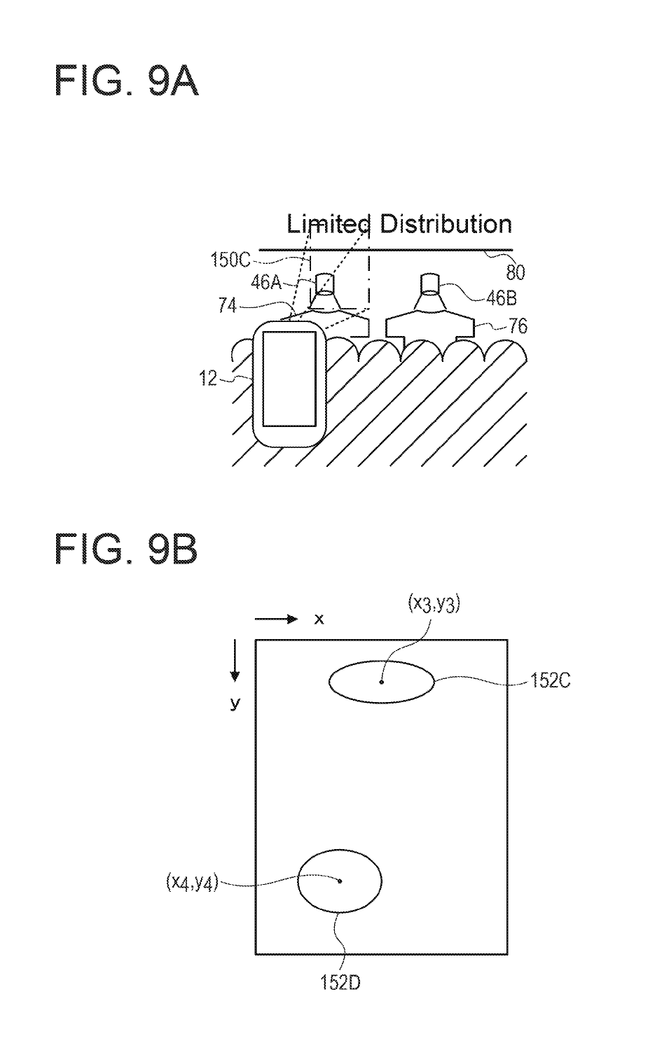

As an example, FIG. 9A illustrates a case where the photographing unit 14 of the terminal device 12 is directed to the signboard 80 or the T-shirt A74 in the commodity exhibition place 72 at an intermediate distance from the commodity exhibition place 72. In this case, the region of the signboard 80 illuminated with the light from the second light source 48 and the region of the T-shirt A74 illuminated with the light from the first light source 46 are present in a photographing range 150C. Therefore, as illustrated in FIG. 9B, a light source region 152C illustrated with the light from the second light source 48 and a light source region 152D illustrated with the light from the first light source 46A are detected from a photographed image. In the present embodiment, the identification information “ID0100” is detected from the detected light source region 152C and the identification information “ID0101” is detected from the detected light source region 152D.

In step 206, the identification information detection unit 20 detects the identification information included in the light source region detected from the image photographed by the photographing unit 14 by the search in step 202 for each detected light source region. The detection of the identification information may be realized, for example, by converting a change in luminance in a time zone in which a regular change in luminance is occurring to code information according to a predetermined conversion rule for each of the individual light source regions 152. Accordingly, as illustrated in FIG. 9B, when a plurality of light source regions 152 is detected, different identification information is detected for different individual light source regions 152.

In step 208, the identification information transmission unit 22 transmits the identification information detected by the identification information detection unit 20 for each light source area, together with the terminal ID of the own device stored in the terminal ID storage area 106 of the storage unit 90, to the connection destination control server 30. In step 210, the connection destination acquisition unit 24 determines whether or not a connection destination address has been received from the connection destination control server 30, and repeats the determination in step 210 until the connection destination address is received from the connection destination control server 30.

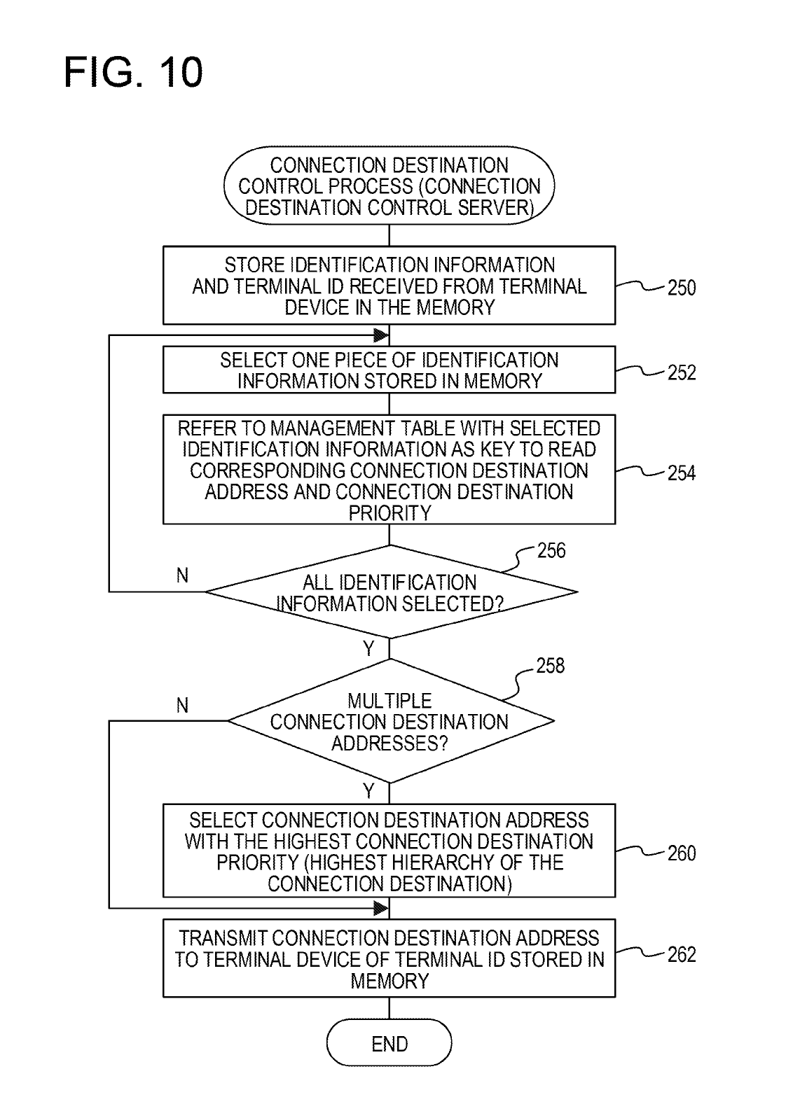

As described above, while the terminal device 12 that transmitted the identification information to the connection destination control server 30 is waiting for the reception of the connection destination address from the connection destination control server 30, the connection destination control server 30 that received the identification information from the terminal device 12 performs the connection destination control process illustrated in FIG. 10.

In step 250 of the connection destination control process, the identification information acquisition unit 32 of the connection destination control server 30 stores the identification information and the terminal ID received from the terminal device 12 in the memory 114. In step 252, the connection destination specifying unit 34 selects one piece of identification information from the identification information stored in the memory 114 by the identification information acquisition unit 32. In step 254, the connection destination specifying unit 34 refers to the management table 44 stored in the storage unit 42 with the identification information selected in step 252 as a key, to read a set of connection destination address and connection destination priority associated with the selected identification information from the management table 44.

In step 256, the connection destination specifying unit 34 determines whether or not all of the identification information stored in the memory 114 has been selected by the identification information acquisition unit 32. When the number i of identification information received from the terminal device 12 is equal to or greater than 2, the determination in step 256 is negated (i−1) times. When the determination in step 256 is negative, the process returns to step 252 and steps 252 to 256 are repeated until the determination in step 256 is affirmative. Accordingly, a set of associated connection destination address and connection destination priority is acquired for each of the identification information received from the terminal device 12. When the determination in step 256 is affirmative, the process proceeds to step 258.

In step 258, the connection destination selection unit 36 determines whether or not there is a plurality of sets of connection destination addresses and connection destination priorities read from the management table 44 by the connection destination specifying unit 34. When the number i of identification information received from the terminal device 12 is 1, one set of corresponding connection destination address and connection destination priority is read from the management table 44 so that the determination in step 258 is negative, and the process proceeds to step 262. In this case, the connection destination selection unit 36 outputs the connection destination address included in the one set read from the management table 44 to the connection destination notification unit 38.

In the meantime, when the number i of identification information received from the terminal device 12 is equal to or greater than 2, i sets of corresponding connection destination addresses and connection destination priorities are read from the management table 44 so that the determination in step 258 is affirmative, and the process proceeds to step 260. In step 260, the connection destination selection unit 36 selects a set having the highest connection destination priority from the read i sets of connection destination addresses and connection destination priorities. The selection corresponds to selecting the connection destination address of the webpage having the highest hierarchy in the specific site from the connection destination addresses included in the i sets. Then, the connection destination selection unit 36 outputs the connection destination address included in the selected set to the connection destination notification unit 38.

When there is a plurality of sets having the highest connection destination priority, the connection destination selection unit 36 selects one from the plurality of sets having the highest connection destination priority. The selection criterion in this case is not particularly limited and, for example, may be selected in an ascending order or a descending order of corresponding identification information. Further, for example, when the x and y coordinates of a light source region are notified from the terminal device 12, a set corresponding to a light source region closer to the center of the photographing range may be selected on the basis of the notified x and y coordinates of the light source region, as will be described in a second embodiment.

In step 262, the connection destination notification unit 38 transmits the connection destination address input from the connection destination selection unit 36 to the terminal device 12 of the terminal ID stored in the memory 114 and then ends the connection destination control process.

When the connection destination acquisition unit 24 of the terminal device 12 that has transmitted the identification information to the connection destination control server 30 acquires the connection destination address transmitted from the connection destination control server 30 by the above-described process, the determination in step 210 of the photographing activation process (FIG. 6) is affirmative and the process proceeds to step 212. In step 212, the site connection unit 26 requests the application server 50 to transmit the corresponding webpage in the specific site by transmitting the connection destination address acquired by the connection destination acquisition unit 24 to the application server 50.

Upon receiving the connection destination address from the terminal device 12, the site information transmission unit 52 of the application server 50 acquires the information of the webpage in the specific site corresponding to the received connection destination address to the specific site information 62 stored in the storage unit 60. Then, the site information transmission unit 52 transmits the acquired webpage information to the terminal device 12 of the connection information transmission source.

Upon receiving the information of the webpage in the specific site from the application server 50, the site connection unit 26 of the terminal device 12 causes the display unit 16 to display the webpage indicated by the received information in step 214 and ends the photographing activation process.

With respect to the webpage displayed on the display unit 16 of the terminal device 12 in the above step 214, the distance between the commodity exhibition place 72 and the photographing position when the user performs the operation of directing the photographing unit 14 of the terminal device 12 to the commodity exhibition place 72 will be described further.

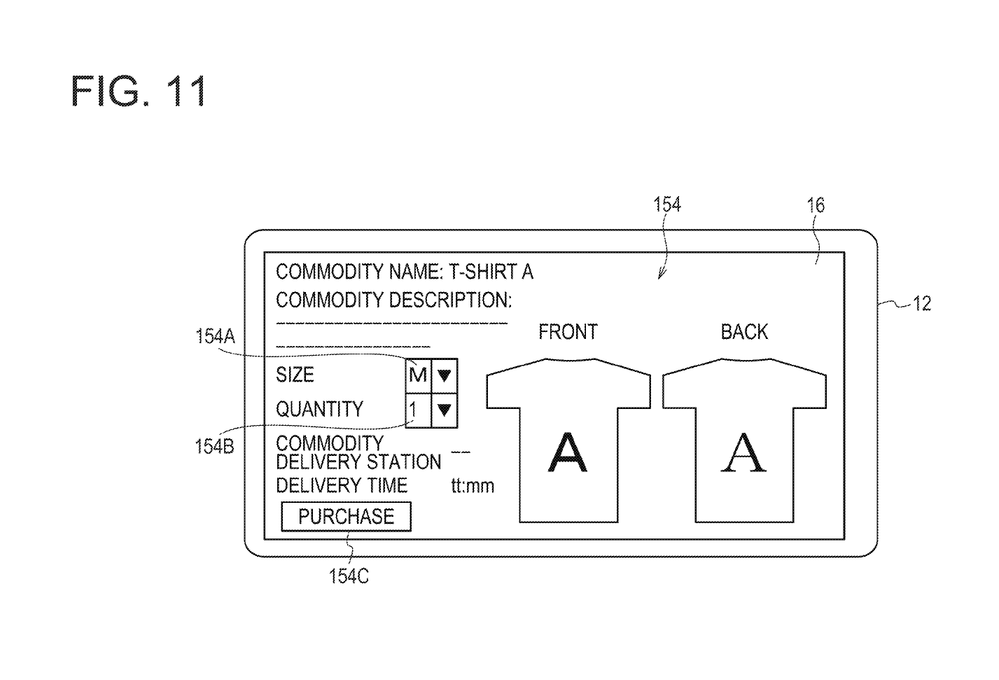

As described above, it is assumed that the first user who desires to check the samples of the commodities waits until arriving in front of the exhibited commodities, checks the samples, and, if the user has a purchase intention, takes an action of directing the photographing unit 14 to a commodity desired to be purchased. In this case, when a commodity to which the photographing unit 14 is directed is the T-shirt A74, as an example, as illustrated in FIG. 7A, an image occupying most of the region of the T-shirt A74 is photographed. Since the T-shirt A74 is illuminated with the light from the first light source 46A and the identification information “ID0101” is contained in the light from the first light source 46A, the identification information “ID0101” is detected from the image. FIG. 11 illustrates an example of a webpage displayed on the display unit 16 of the terminal device 12 in this case. The webpage illustrated in FIG. 11 is an example of the webpage specified by the connection destination address associated with the identification information “ID0101” in FIG. 3.

An individual commodity webpage 154 displaying the detailed information of the T-shirt A74 is displayed on the display unit 16 of the terminal device 12 in FIG. 11. The individual commodity webpage 154 is displayed with information such as a detailed image of the T-shirt A74 and a commodity description and includes a designation column 154A for designating the size of a commodity to be purchased, a designation column 154B for designating the quantity of commodities to be purchased, and a button 154C for instructing purchase. Accordingly, the first user who takes an action of directing the photographing unit 14 to the T-shirt A74 may immediately perform an operation for purchasing the T-shirt A74 on the individual commodity webpage 154 displayed first on the display unit 16 of the terminal device 12. Therefore, it is possible to save the labor of the operation by the first user who intends to purchase the commodity, thereby improving the convenience of the first user.

A commodity delivery station and a delivery time are also displayed on the individual commodity webpage 154. When a plurality of commodity delivery stations are provided in the specific venue 70 and a user wishes to deliver a commodity at one of the commodity delivery stations, the user may designate a particular commodity delivery station at which the commodity is to be delivered. Further, for example, the delivery management unit 58 of the application server 50 may designate a particular commodity delivery station at which the commodity is to be delivered, so that congestion in the commodity delivery stations is leveled. In addition, the delivery time may also be designated by the user or the delivery management unit 58 of the application server 50 so that congestion in time zones of the commodity delivery stations is leveled.

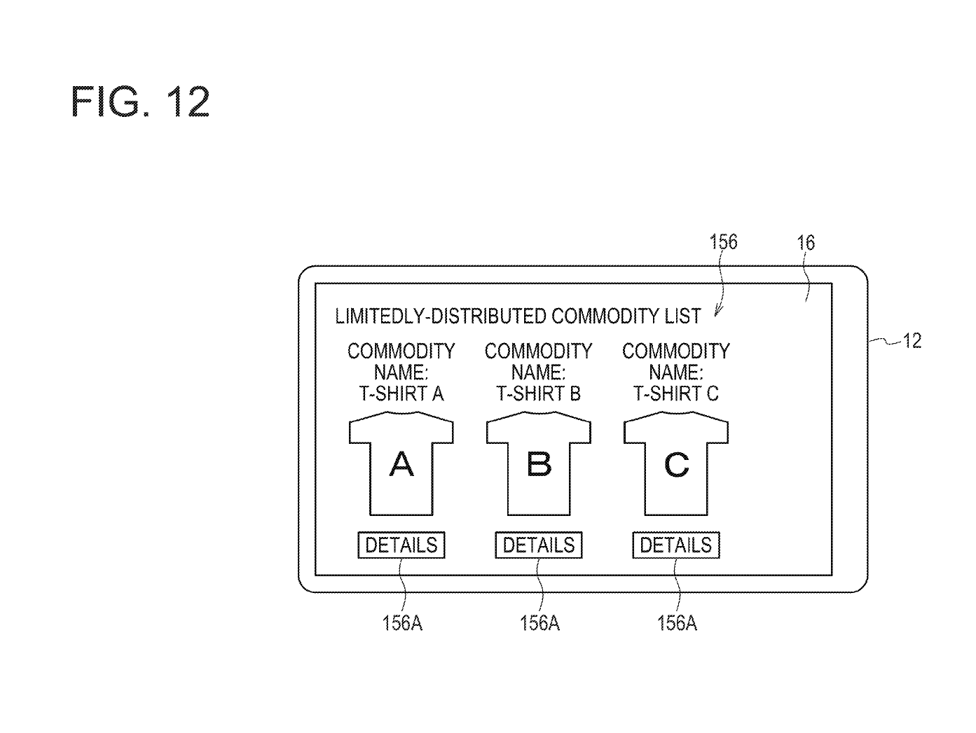

It is also assumed that the second user who wishes to check and select a commodity at the specific site takes an action of directing the photographing unit 14 of the terminal device 12 to the signboard 80 of the commodity exhibition place 72 at a position away from the commodity exhibition place 72. In this case, as an example, as illustrated in FIG. 8A, an image in which the region of the signboard 80 occupies a large area is photographed. Since the signboard 80 is illuminated with the light from the second light source 48 and the identification information “ID0100” is contained in the light from the second light source 48, the identification information “ID0100” is detected from the image. FIG. 12 illustrates an example of a webpage displayed on the display unit 16 of the terminal device 12 in this case. The webpage illustrated in FIG. 12 is an example of a webpage specified by the connection destination address associated with the identification information “ID0100” in FIG. 3.

As illustrated in FIG. 12, a commodity list webpage 156 displaying the list information of T-shirt A74 to T-shirt C78 is displayed on the display unit 16 of the terminal device 12 at a higher hierarchy in the specific site than the individual commodity webpage 154. The commodity list webpage 156 is displayed with names and thumbnail images of individual commodities and includes buttons 156A for instructing transition of the individual commodities to the individual commodity webpage 154. Accordingly, the second user who takes the action of directing the photographing unit 14 to the signboard 80 of the commodity exhibition place 72 can check the exhibition of initially limitedly-distributed commodities on the commodity list webpage 156 first displayed on the display unit 16 of the terminal device 12.

Accordingly, it is possible to offer information on the exhibited commodities to the second user who is interested in the commodities exhibited in the commodity exhibition place 72 without consuming the time taken to approach the commodity exhibition place 72, thereby improving the convenience of the second user. In addition, since it is not necessary for the second user to approach the commodity exhibition place 72, it is possible to alleviate the congestion at the commodity exhibition place 72.

It may be also considered that a user takes an action of directing the photographing unit 14 of the terminal device 12 to the signboard 80 or the exhibited commodities of the commodity exhibition place 72 at the photographing position in FIG. 7A and the middle of the photographing position in FIG. 8A. In this case, as an example, as illustrated in FIG. 9A, when the region of the signboard 80 and the region of the T-shirt A74 are included in the photographing range 150C of the photographing unit 14, as illustrated in FIG. 9B, the light source region 152C corresponding to the signboard 80 and the light source region 152D corresponding to the T-shirt A74 are detected. Since the signboard 80 is illuminated with the light from the second light source 48 containing the identification information “ID0100”, the identification information “ID0100” is detected from the light source region 152C corresponding to the signboard 80. Further, since the T-shirt A74 is illuminated with the light from the first light source 46A containing the identification information “ID0101”, the identification information “ID0101” is detected from the light source region 152D corresponding to the T-shirt A74.

In this case, the connection destination specifying unit 34 of the connection destination control server 30 reads two sets of connection destination addresses and connection destination priorities from the management table 44 in association with the identification information “ID0100” and “ID0101”, respectively. In addition, the connection destination selection unit 36 selects the connection destination address corresponding to the identification information “ID0100” because the connection destination priority is higher in the identification information “ID0100” than the identification information “ID0110”. As a result, the commodity list webpage 156 illustrated in FIG. 12 is displayed on the display unit 16 of the terminal device 12.

Here, when the identification information contained in the light from the first light source 46 and the identification information contained in the light from the second light source 48 are detected in the photographed image, the reason for selection a connection destination of a higher hierarchy corresponding to the identification information contained in the light from the second light source 48 is as follows. In the present embodiment, the second light source 48 illuminates a higher range of the commodity exhibition place 72 than the first light source 46. Therefore, when the identification information contained in the light from the first light source 46 and the identification information contained in the light from the second light source 48 are detected in the photographed image, it can be determined that the distance between the photographing position and the commodity exhibition place 72 is farther than when only the identification information contained in the light from the first light source 46 is detected.

Even when the identification information contained in the light from the first light source 46 illuminating the individual commodities is detected in the photographed image, since the distance between the photographing position and the commodities illuminated with the light from the first light source 46 is too far, it is difficult to determine that a user is willing to purchase the commodities. Therefore, in the present embodiment, when the identification information contained in the light from the first light source 46 and the identification information contained in the light from the second light source 48 are detected, a connection destination of a higher hierarchy corresponding to the identification information contained in the light from the second light source 48 is selected. Accordingly, it is possible to reduce the possibility that a user who performs the operation of directing the photographing unit 14 to an object feels uncomfortable with the webpage initially displayed on the display unit 16 of the terminal device 12.

### Second Embodiment

Next, a second embodiment will be described. The second embodiment has the same configuration as the first embodiment and therefore, the same units and parts are denoted by the same reference numerals and explanation of which will not be repeated for the purpose of brevity.

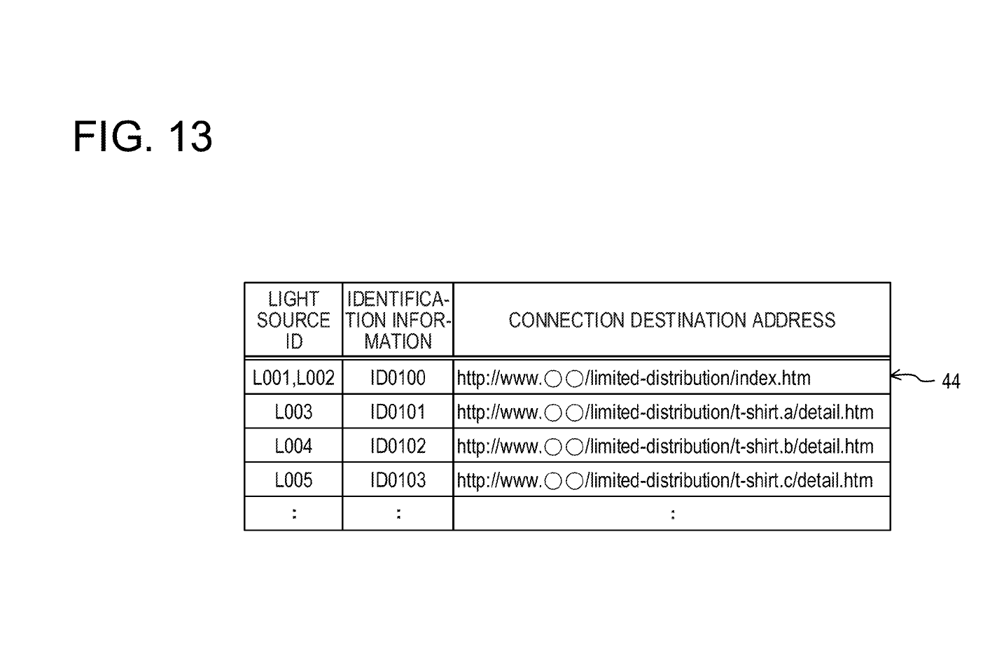

As illustrated in FIG. 13, the management table 44 in the second embodiment is different from the management table (FIG. 3) described in the first embodiment in that a connection destination priority is not stored.

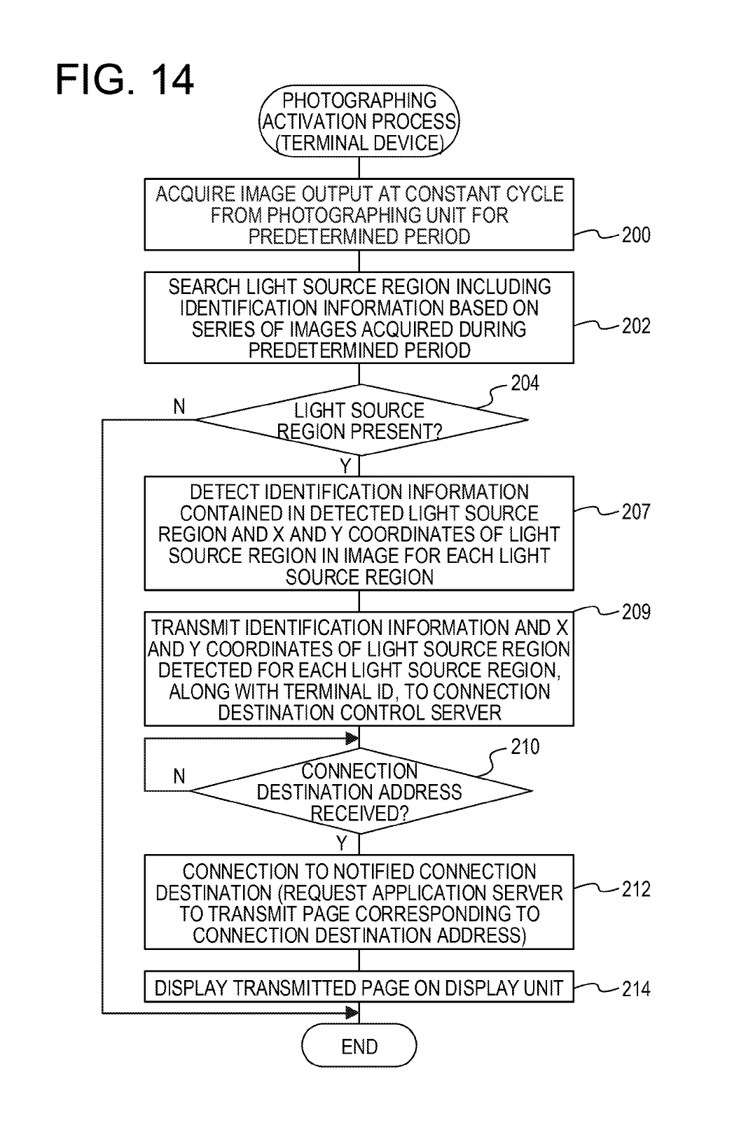

Next, with respect to a photographing activation process according to the second embodiment, portions different from the photographing activation process (FIG. 6) described in the first embodiment will be described with reference to FIG. 14. When the determination in step 204 is affirmative as a light source region is detected from a series of images photographed by the photographing unit 14 within a predetermined period, the photographing activation process according to the second embodiment proceeds to step 207.

In step 207, the identification information detection unit 20 detects the identification information contained in the light source region detected from the image photographed by the photographing unit 14 in the search of step 202 and the x and y coordinates of the light source region in the photographed image for each detected light source region. As the x and y coordinates of the light source region, for example, the x and y coordinates of a position of the center of gravity of the light source region may be applied, but without being limited thereto. For example, as the x and y coordinates of the light source region, the median value of the x coordinate value range of the light source region and the median value of the y coordinate value range thereof may be used.

According to the process of step 207, for example, as illustrated in FIG. 7B, when the light source region 152A is detected from the photographed image, (x1, y1) is detected as the x and y coordinates of the light source region 152A. Further, for example, as illustrated in FIG. 8B, when the light source region 152B is detected from the photographed image, (x2, y2) is detected as the x and y coordinates of the light source region 152B. Further, for example, as illustrated in FIG. 9B, when the light source regions 152C and 152D are detected from the photographed image, (x3, y3) is detected as the x and y coordinates of the light source region 152C and (x4, y4) is detected as the x and y coordinates of the light source region 152D.

In step 209, the identification information transmission unit 22 transmits the identification information and the x and y coordinates of the light source region detected by the identification information detection unit 20 for each light source region to the destination control server 30, together with the terminal ID of its own device.

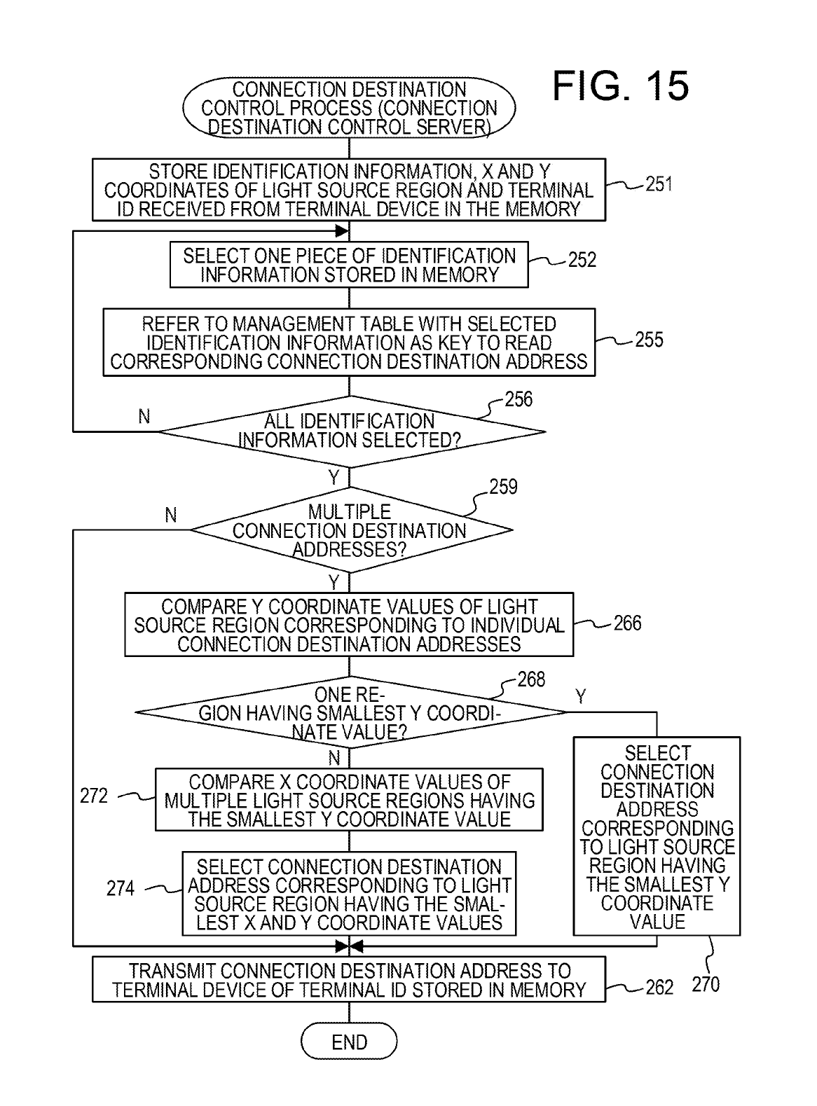

Next, with respect to a connection destination control process according to the second embodiment, portions different from the connection destination control process (FIG. 10) described in the first embodiment will be described with reference to FIG. 15. In the connection destination control process according to the second embodiment, in step 251, the identification information acquisition unit 32 stores the identification information, the x and y coordinates of the light source region and the terminal ID received from the terminal device 12 in the memory 114. In step 255 subsequent to step 252, the connection destination specifying unit 34 refers to the management table 44 stored in the storage unit 42 with the identification information selected in step 252 as a key. Then, the connection destination specifying unit 34 reads a connection destination address associated with the selected identification information from the management table 44.

In addition, when the determination in step 256 is affirmative as the connection destination specifying unit 34 selects all the identification information stored in the memory 114 by the identification information acquisition unit 32, the process proceeds to step 259. In step 259, the connection destination selection unit 36 determines whether or not there is a plurality of connection destination addresses read from the management table 44 by the connection destination specifying unit 34. When the determination in step 259 is affirmative, the process proceeds to step 266.

In step 266, the connection destination selection unit 36 compares the magnitude relation between y coordinate values in the x and y coordinates of the plurality of light source regions stored in the memory 114 in association with the individual connection destination addresses read from the management table 44 by the connection destination specifying unit 34. In the next step 268, the connection destination selection unit 36 determines whether or not the number of light source regions having the smallest y coordinate value is one.

Based on the direction of the y coordinate axis illustrated in FIG. 7B or the like, it can be determined that the light source region having the smaller y coordinate value is positioned higher in the space of the commodity exhibition place 72 photographed by the photographing unit 14. Therefore, when the determination in step 268 is affirmative, the process proceeds to step 270. In step 270, the connection destination selection unit 36 selects a connection destination address corresponding to the light source region having the smallest y coordinate value from the plurality of connection destination addresses read from the management table 44, and the process proceeds to step 262.

As described above, in the present embodiment, as the illumination range of the light from a light source in the venue 70 (the commodity exhibition place 72) becomes higher, it is set that a connection destination associated with the identification information contained in the light becomes a webpage of a higher hierarchy in the specific site. Therefore, by selecting the connection destination address corresponding to the light source region having the smallest y coordinate value, the webpage of the higher hierarchy in the specific site is selected as a connection destination.

In the meantime, when there is a plurality of light source regions having the smallest y coordinate value, the determination in step 268 is negative and the process proceeds to step 272. In step 272, the connection destination selection unit 36 compares the magnitude relation between x coordinate values in the x and y coordinates with respect to the plurality of light source regions having the smallest y coordinate value. In step 274, the connection destination selection unit 36 selects a connection destination address corresponding to the light source region having the smallest x coordinate value and y coordinate value from the plurality of connection destination addresses read from the management table 44, and the process proceeds to step 262.

Also, in step 274, the x coordinate value is not limited to selecting the connection destination address corresponding to the smallest light source region. For example, a value closer to the center in the x direction in the photographed image may be selected as the x coordinate value and a connection destination address corresponding to the smallest light source region may be selected as the y coordinate value.

### Third Embodiment

Next, a third embodiment will be described. In the third embodiment, the same units and parts as the first and second embodiments are denoted by the same reference numerals and explanation of which will not be repeated for the purpose of brevity.

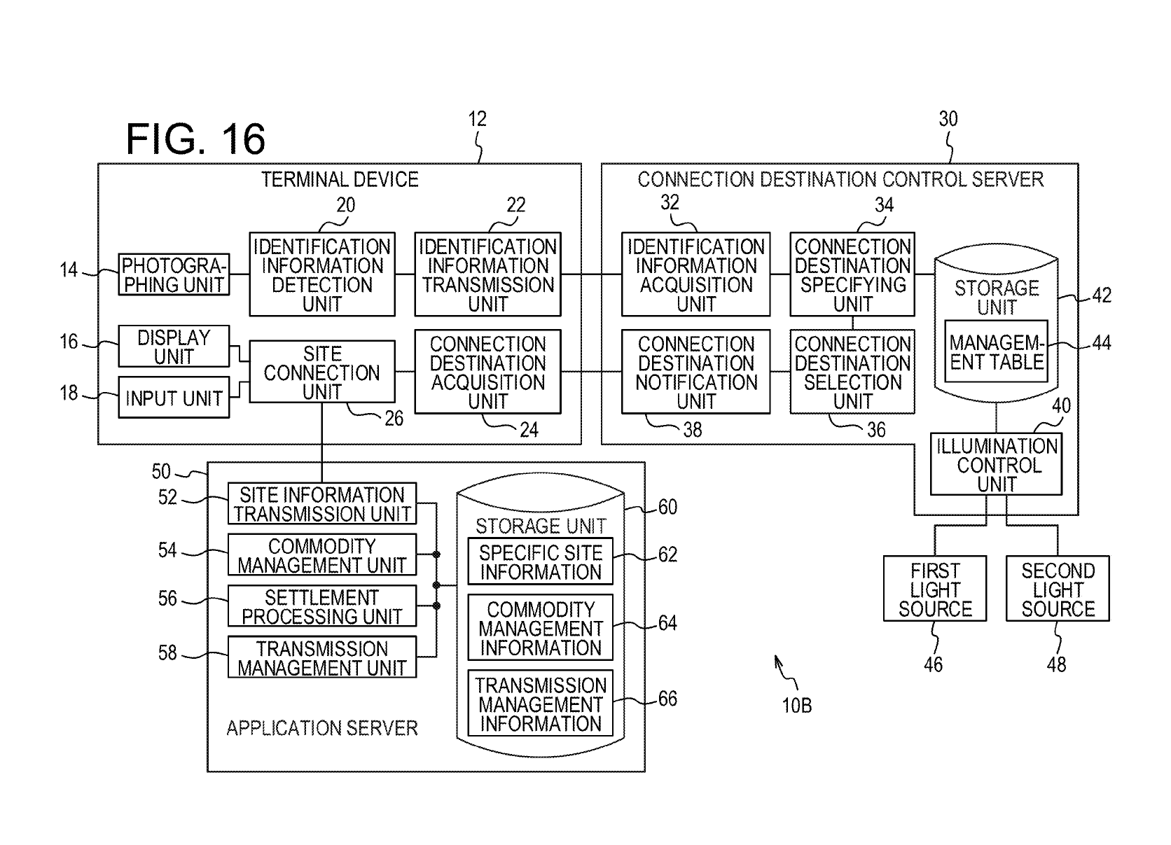

As illustrated in FIG. 16, a commodity purchase support system 10B according to the third embodiment is different from the commodity purchase support system 10A (FIG. 1) described in the first embodiment in that the connection destination specifying unit 34 of the connection destination control server 30 is connected to the application server 50. In the third embodiment, the specific site realized by the specific site information 62 stored in the storage unit 60 of the application server 50 provides a user with a function of searching the site using search conditions such as keywords (not illustrated).

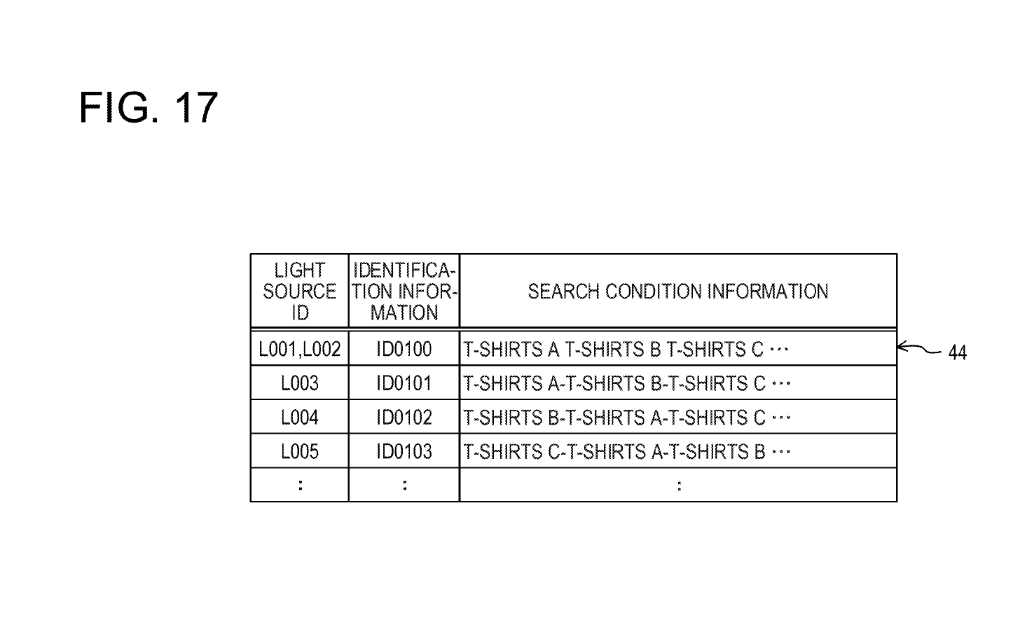

Further, as illustrated in FIG. 17, the management table 44 in the third embodiment is different from the management table (FIG. 13) described in the second embodiment in that search condition information is registered instead of the connection destination address. When the specific site is searched with designated search condition information, information equivalent to the connection destination address described in the first and second embodiments is notified from the application server 50. The search condition information is an example of connection destination information recited in the present disclosure.

That is, a connection destination address for designating the commodity list webpage as a connection destination is registered in the management table 44 described in the first and second embodiments in association with the identification information “ID0100”. In contrast, in the management table 44 illustrated in FIG. 17, the search condition information associated with the identification information “ID0100” is notified, as a connection destination address of the commodity list webpage by in-situ search of the specific site, from the application server 50. More specifically, the search condition information associated with the identification information “ID0100” is set so that the names of a plurality of products (T-shirt A74 to T-shirt C78) are searched under AND conditions.

Further, a connection destination address for designating the individual commodity webpage of the T-shirt A74 as a connection destination is registered in the management table 44 described in the first and second embodiments in association with the identification information “ID0101”. In contrast, in the management table 44 illustrated in FIG. 17, the search condition information associated with the identification information “ID0101” is set so that the connection destination address of the individual commodity webpage of T-shirt A74 can be acquired by in-situ search of the specific site. More specifically, the search condition information associated with the identification information “ID0101” is set so that the name of the T-shirt A74 becomes a search target and the names of the T-shirt B76 and the T-shirt C78 become targets to be excluded from the search.

Similarly to the search condition information associated with the identification information “ID0101”, the search condition information associated with the identification information “ID0102” and “ID0103” is set so that commodities other than the search targets become targets to be excluded from the search and therefore, explanation of which will not be repeated for the purpose of brevity.

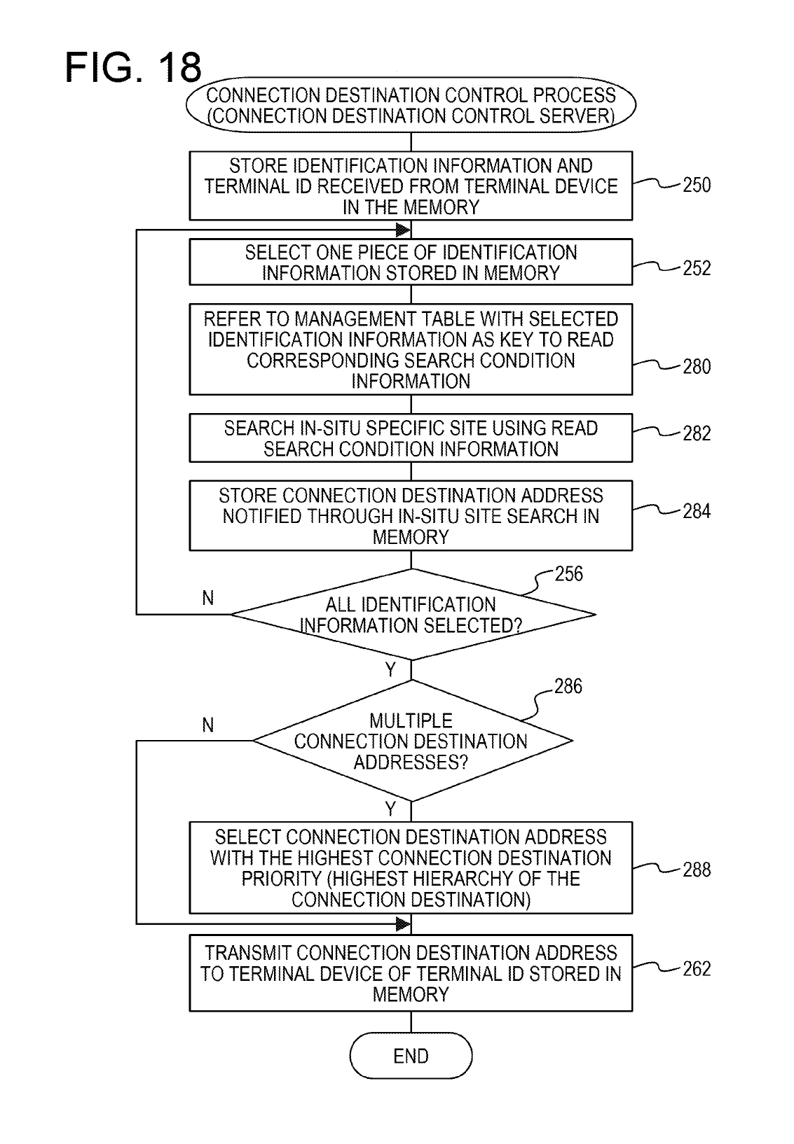

Next, with respect to a connection destination control process according to the third embodiment, portions different from the connection destination control process (FIG. 10) described in the first embodiment will be described with reference to FIG. 18. In the connection destination control process according to the third embodiment, in step 280 subsequent to step 252, the connection destination specifying unit 34 refers to the management table 44 with the identification information selected in step 252 as a key. Then, the connection destination specifying unit 34 reads search condition information associated with the selected identification information from the management table 44.

In step 282, the connection destination specifying unit 34 transmits the connection destination address of the specific site and the search condition information read from the management table 44 to the application server 50, and causes the application server 50 to perform the in-situ site search with the search condition information. Accordingly, the application server 50 performs the in-situ search of the specific site and a connection destination address of a hit webpage is notified from the application server 50. In the next step 284, the connection destination specifying unit 34 stores the connection destination address notified through the in-situ search of the specific site by the application server 50 in the memory 114.

When the determination in step 256 is affirmative as the connection destination specifying unit 34 selects all the identification information stored in the memory 114 by the identification information acquisition unit 32, the process proceeds to step 286. In step 286, the connection destination selection unit 36 determines whether or not there is a plurality of connection destination addresses notified from the application server 50 and stored in the memory 114. When the number of connection destination addresses stored in the memory 114 is one, the determination in step 286 is negative, the connection destination address stored in the memory 114 is output to the connection destination notification unit 38, and the process proceeds to step 262.

When a plurality of connection destination addresses is stored in the memory 114, the determination in step 286 is affirmative and the process proceeds to step 288. In step 288, the connection destination selection unit 36 selects a connection destination address having the highest connection destination hierarchy from the plurality of connection destination addresses stored in the memory 114. For example, when the connection destination address is a URL, the connection destination address having the highest connection destination hierarchy can be selected, for example, by selecting a connection destination having the smallest number of “/” included in the connection destination address. In addition, when the connection destination address is other than the URL, the connection destination address having the highest connection destination hierarchy may be selected by examining the number of other characters or the like according to the description format of the connection destination address. Then, upon selecting the connection destination address having the highest connection destination hierarchy, the connection destination selection unit 36 outputs the selected connection destination address to the connection destination notification unit 38, and the process proceeds to step 262.

As described above, in the above embodiments, the identification information acquisition unit 32 acquires a plurality of pieces of identification information contained in detected light based on an image photographed by the photographing unit 14. In addition, the connection destination specifying unit 34 refers to the storage unit 42 in which the identification information and the connection destination information associated with any one of hierarchies of a website are stored in association with each other to specify a plurality of pieces of connection destination information associated respectively with the plurality of identification information. Then, the connection destination selection unit 36 selects the connection destination information associated with the highest hierarchy from the plurality of specified connection destination information as a connection destination according to the acquisition of the plurality of identification information. Thus, when the plurality of pieces of identification information is detected from the photographed image, an appropriate connection destination can be selected.

In the second embodiment, when a plurality of connection destination addresses is read from the management table 44, a connection destination address corresponding to a light source region having the smallest y coordinate value is selected based on the x and y coordinates of the corresponding plural light source regions. This can result in reduction in storage capacity for storing the management table 44. In addition, for example, when a plurality of connection destination addresses in the same hierarchy is read out, a connection destination address corresponding to a light source region having a higher possibility that a user is being photographed as the main subject can be selected based on the x and y coordinates of the plurality of corresponding light source regions.

Further, in the third embodiment, by registering the search condition information in the management table 44 and performing the in-situ search of the specific site based on the search condition information, a connection destination address corresponding to the identification information detected from the photographed image is acquired. Accordingly, even when a connection destination address of a webpage in the specific site is changed, there is no need to update the information registered in the management table 44, thereby improving the maintainability of the connection destination control server 30.

In the above description, the aspect in which limitedly-distributed commodities aimed at users who visited the specific venue 70 where a specific event is held are exhibited in the commodity exhibition place 72 in the venue 70 has been described, but the present disclosure is not limited thereto. For example, an object to be illuminated with light containing the identification information may be an exhibit which is not a target of commercial transaction, for example, an exhibit in a museum or an art museum. In this case, a website having a plurality of hierarchies may be a site including a webpage providing detailed information of one exhibit and a webpage providing list information of a plurality of exhibits.

In the above description, the aspect in which the server computer 110 functions as the connection destination control server 30 by causing the server computer 110 to execute the connection destination control program 126, which is an example of the connection destination control program according to the present disclosure, has been described. However, the present disclosure is not limited thereto. For example, by causing the terminal device 84 to execute the connection destination control program according to the present disclosure, the terminal device 84 may function as the connection destination control device according to the present disclosure.

In the above description, the aspect in which the connection destination control program 126 serving as an example of the connection destination control program according to the present disclosure is stored (installed) in the storage unit 116 has been described. However, the present disclosure is not limited thereto. For example, the connection destination control program according to the present disclosure may be provided in a form recorded on a recording medium such as a CD-ROM, a DVD-ROM, a memory card or the like.

All literatures, patent applications and technical standards described in this specification are incorporated in this specification by reference to the same extent as if the individual literatures, patent applications and technical standards were specifically and individually written and incorporated by reference.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
acquiring a plurality of pieces of identification information contained in light detected based on an image photographed by a photographing device;
referring to a storage unit that stores identification information and connection destination information associated with one of a plurality of hierarchies of a website in association with each other to specify a plurality of pieces of connection destination information associated respectively with the plurality of pieces of identification information; and
selecting connection destination information associated with the highest hierarchy from the plurality of specified connection destination information as a connection destination according to the acquiring of the plurality of pieces of identification information.

2. The non-transitory computer-readable recording medium according to claim 1, wherein the website having the plurality of hierarchies is a website capable of performing an electronic commerce of commodities.

3. The non-transitory computer-readable recording medium according to claim 1, wherein, when the plurality of pieces of connection destination information includes first connection destination information associated with a hierarchy of a webpage including information on a specific commodity and second connection destination information associated with a hierarchy of a webpage including list information on a plurality of commodities including the specific commodity, connection destination information associated with the highest hierarchy is the second connection destination information.

4. The non-transitory computer-readable recording medium according to claim 1, wherein first identification information contained in light irradiated on a first object by a first light source corresponds to first connection destination information associated with a first webpage including information of the first object among websites having the plurality of hierarchies, and
second identification information contained in light irradiated by a second light source on a second object located at a higher position than the first object corresponds to second connection destination information which is associated with a second webpage including list information on a plurality of objects including the first object and having a hierarchy higher than the first webpage, among the websites having the plurality of hierarchies.

5. A connection destination control method, comprising:
acquiring, by a processor, a plurality of pieces of identification information contained in light detected based on an image photographed by a photographing device;
referring to a storage unit that stores identification information and connection destination information associated with one of a plurality of hierarchies of a website in association with each other to specify a plurality of pieces of connection destination information associated respectively with the plurality of pieces of identification information; and
selecting connection destination information associated with the highest hierarchy from the plurality of specified connection destination information as a connection destination according to the acquiring of the plurality of pieces of identification information.

6. The connection destination control method according to claim 5, wherein the website having the plurality of hierarchies is a website capable of performing an electronic commerce of commodities.

7. The connection destination control method according to claim 5, wherein, when the plurality of pieces of connection destination information includes first connection destination information associated with a hierarchy of a webpage including information on a specific commodity and second connection destination information associated with a hierarchy of a webpage including list information on a plurality of commodities including the specific commodity, connection destination information associated with the highest hierarchy is the second connection destination information.

8. The connection destination control method according to claim 5, wherein first identification information contained in light irradiated on a first object by a first light source corresponds to first connection destination information associated with a first webpage including information of the first object among websites having the plurality of hierarchies, and
second identification information contained in light irradiated by a second light source on a second object located at a higher position than the first object corresponds to second connection destination information which is associated with a second webpage including list information on a plurality of objects including the first object and having a hierarchy higher than the first webpage, among the websites having the plurality of hierarchies.

9. A connection destination control device, comprising:
a memory; and
a processor coupled to the memory and the processor configured to:
acquire a plurality of pieces of identification information contained in light detected based on an image photographed by a photographing device;
refer to a storage unit that stores identification information and connection destination information associated with one of a plurality of hierarchies of a website in association with each other to specify a plurality of pieces of connection destination information associated respectively with the plurality of pieces of identification information; and
select connection destination information associated with the highest hierarchy from the plurality of specified connection destination information as a connection destination according to the acquisition of the plurality of pieces of identification information.

10. The connection destination control device according to claim 9, wherein the website having the plurality of hierarchies is a website capable of performing an electronic commerce of commodities.

11. The connection destination control device according to claim 9, wherein, when the plurality of pieces of connection destination information include first connection destination information associated with a hierarchy of a webpage including information on a specific commodity and second connection destination information associated with a hierarchy of a webpage including list information on a plurality of commodities including the specific commodity, connection destination information associated with the highest hierarchy is the second connection destination information.

12. The connection destination control device according to claim 9, wherein first identification information contained in light irradiated on a first object by a first light source corresponds to first connection destination information associated with a first webpage including information of the first object among websites having the plurality of hierarchies, and
second identification information contained in light irradiated by a second light source on a second object located at a higher position than the first object corresponds to second connection destination information which is associated with a second webpage including list information on a plurality of objects including the first object and having a hierarchy higher than the first webpage, among the websites having the plurality of hierarchies.
